(19) United States
(12) Patent Application Publication
(10) Pub. No.: US 2025/0200023 A1
(43) Pub. Date: Jun. 19, 2025

(54) METHOD AND APPARATUS FOR PROCESSING BLOCKCHAIN TRANSACTIONS

(71) Applicant: ELECTRONICS AND TELECOMMUNICATIONS RESEARCH INSTITUTE, Daejeon (KR)

(72) Inventor: Changhyun LEE, Daejeon (KR)

(21) Appl. No.: 18/968,805

(22) Filed: Dec. 4, 2024

(30) Foreign Application Priority Data
Dec. 15, 2023 (KR) 10-2023-0182774

(51) Int. Cl. G06F 16/23

(52) U.S. Cl. CPC G06F 16/2379

(57) ABSTRACT

The present disclosure provides a method and apparatus for processing blockchain transactions that may reduce a number of disk read operations in a full node in a blockchain network. The method includes: reading a state value required for processing a transaction of a new block from a local disk in a same order as an order of processing transactions of a plurality of new blocks; creating a state snapshot including the state value; and sharing the state snapshot with at least one second full node.

### CROSS-REFERENCE TO RELATED APPLICATION

The present application claims a convention priority under 35 U.S.C. § 119(a) based on Korean Patent Application No. 10-2023-0182774 filed on Dec. 15, 2023, the entire content of which is incorporated herein in its entirety by reference.

### BACKGROUND

### 1. Technical Field

The present disclosure relates to a blockchain transaction processing technology and, more specifically, to a blockchain transaction processing method and device enabling to reduce a number of disk read operations.

### 2. Related Art

Blockchain may be abstractly expressed as a state machine that changes a state of the system by executing transactions. In case of Ethereum which may be one of representative blockchains, the state may be a balance of a user account or a value stored in a variable of a smart contract code. The state may be updated whenever a transaction generated by a user is executed.

An execution of the transaction and an update of the state may be performed at two points in time, that is, when a block is generated or when the block is validated. When the block is generated, a block generation node referred to as a miner or validator may sequentially execute unprocessed transactions stored in its local mempool to update a relevant state, calculate a new state root which is a hash value for the entire states, and insert the state root into the block header.

A full node receiving a newly generated block may sequentially execute the transactions contained in the block, update the state stored in the node, and validate an execution result by calculating the state root and comparing with a value in the block header. Meanwhile, when the node receives a new transaction, the node may partially perform an operation of reading the state to check its legitimacy rather than executing the transaction immediately.

In order to perform the above tasks, the blockchain full node such as the miner or the validator has to maintain the entire state information of the blockchain by using an authenticated data storage to enable the validation of each state value.

According to the scheme, the node newly joining the blockchain network may quickly be synchronized to latest states. Also, when a light node which does not have some of the blockchain ledger information requests a state value from the full node, the full node may validate the integrity of the state value by using a proof of stake or another proof.

Ethereum uses a modified Merkle Patricia trie for a data structure storing the states to perform the function of the authenticated data storage, and other blockchain platforms also use a similar Merkle tree-based structure.

The Ethereum platform maintains four trees: a state trie, a storage trie, a receipts trie, and a transaction trie. A Merkle tree is a structure in which a parent node stores a hash value of a value of a child node and has a property that, when a state value stored in a leaf node is updated, all node values in the path from the leaf node to a root node at the top must be updated. Accordingly, a total of n states are stored in the Merkle tree, an overhead of O(log n) occurs to read and write one state.

The entire blockchain state information is so huge enough to reach hundreds of gigabytes in case of the Ethereum, making it difficult to store all the data in the local memory, and thus is stored on a disk through a key-value database (DB) such as LevelDB. Therefore, in the process of updating the state, disk read and write operations which are much slower than a memory access occur several times to read the existing state and store a new state on the disk. Some information may be cached in the memory during the above process to improve performance, but the use of the cashing may be limited inevitably.

Recently, academic researchers have pointed out that the overhead of disk read and write operations may act as a bottleneck in blockchain transaction processing performance. Further, the frequent disk I/O may also reduce a life of the disk. To solve this problems, existing studies have proposed new data structures which may improve the inefficiency of the Merkle tree, or a concept of a helper node that receives transactions from users and performs pre-executions to provide other nodes with pre-execution results before executing the transaction.

However, the use of the new data structures from the existing studies may cause compatibility issues with the blockchain data having been accumulated over the years. The use of a special node such as the helper node may cause the blockchain system to depend on the availability of the special node, which may violate a full decentralization policy of the blockchain.

### SUMMARY

To solve the above problems, one object of the present disclosure is to provide a blockchain transaction processing method and device which may reduce a number of disk read operations occurring in a process of executing a transaction and updating a state in a blockchain full node.

Another object of the present disclosure is to provide a blockchain transaction processing method and device which may reduce the number of disk read operations in a blockchain full node by sharing information for processing a transaction of a new block among a plurality of full nodes to reduce disk loads.

Yet another object of the present disclosure is to provide a blockchain transaction processing method and device which may enhancing a balancing environment of a blockchain network by reducing the load of disk resources that is poor compared to relatively abundant network resources.

According to an aspect of an exemplary embodiment, provided is a blockchain transaction processing method performed by a first full node. The blockchain transaction processing method includes: reading a state value required for processing a transaction of a new block from a local disk in a same order as an order of processing transactions of a plurality of new blocks; creating a state snapshot including the state value; and sharing the state snapshot with at least one second full node.

A format of the state snapshot may include a block number field, a transaction index field, a state key field, a state value field, and a Merkle proof field.

The format of the state snapshot may include a number of state values field.

The operation of sharing the state snapshot with at least one second full node may include: transferring the state snapshot by broadcast to peer nodes and transmitting the above state snapshot to peer nodes including at least one other full node of the blockchain network.

Regarding the operation of transferring the state snapshot, a scheme for the at least one second full node to receive the state snapshot may be set in advance during a handshake between the first full node and the at least one second full node.

The scheme for the at least one second full node to receive the state snapshot may include a push type receiving scheme and a pull type receiving scheme. The push type receiving scheme may include: receiving, by the first full node, a sharing request for the state snapshot from the at least one second full node; and transmitting the state snapshot to the at least one second full node.

The blockchain transaction processing method may further include: receiving another state snapshot including another state value for another new block from a full node belonging to the at least one second full node.

According to another aspect of an exemplary embodiment, provided is a blockchain transaction processing method performed by a second full node. The blockchain transaction processing method includes: receiving a new block; and receiving a state snapshot including a state value required to process a transaction of a new block from a first full node to share the state snapshot with the first full node.

A format of the state snapshot may include a block number field, a transaction index field, a state key field, a state value field, and a Merkle proof field.

The blockchain transaction processing method may further include: determining a validity of the state value based on a block number and a transaction index included in the state snapshot.

The blockchain transaction processing method may further include: when the state value is valid, storing the state value in a memory storage; and when the state value is not valid, ignoring or discarding the state value.

The blockchain transaction processing method may further include: when there exist a plurality of new blocks, checking the block number field for the state value stored in a particular memory space whenever an execution of the transaction is completed; and removing the state value generated earlier than a state value of a block of which transaction execution was most recently completed.

The operation of receiving the state snapshot may be performed according to a receiving scheme set in advance during a handshake with the first full node.

The receiving scheme may include a push type receiving scheme and a pull type receiving scheme. The operation of receiving the state snapshot according to the push type receiving scheme may include: transmitting a request message to the first full node to request the state value; and receiving the state snapshot comprising the state value.

The blockchain transaction processing method may further include: standing by for a preset time until receiving the state value required to process the transaction of the new block from the first full node.

The blockchain transaction processing method may further include: determining whether the state value required to process the transaction of the new block exists in a cache; and if the state value required to process the transaction of the new block does not exist in the cache, fetching the state value from a memory space storing the state value shared with the first full node to process the transaction.

According to yet another aspect of an exemplary embodiment, provided is a blockchain transaction processing apparatus controlling and operating a blockchain node implemented based on a desktop computer or a mobile terminal participating in a blockchain network. The blockchain transaction processing apparatus includes a processor configured to receive at least one instruction from a memory and execute the at least one instruction. The processor is caused by the at least one instruction to: access a local disk storing state information shared between full nodes; read a state value required for processing a transaction of a new block from the local disk in a same order as an order of processing transactions of a plurality of new blocks; create a state snapshot including the state value; and share the state snapshot with other nodes including at least one second full node.

The format of the state snapshot may include a block number field, a transaction index field, a state key field, a state value field, and a Merkle proof field.

The at least one instruction causing the processor to share the state snapshot with other nodes may be configured to cause the processor to transfer the state snapshot by broadcast to nodes including the at least one second full node of the blockchain network. A receiving scheme of the nodes may set in advance during a handshake with the first full node providing the state snapshot.

The other nodes may include at least one of a desktop wallet, a mobile wallet, a hardware wallet, and a web wallet.

An exemplary embodiment of the present disclosure enables to decrease the number of disk read operations and reduce the disk loads.

An exemplary embodiment of the present disclosure enables a plurality of full nodes to share the state values for processing the transaction of a new block so as to decrease the number of disk read operations and improve the performance of processing the blockchain transactions.

According to an exemplary embodiment of the present disclosure, the reduction of the number of disk read operations by sharing the state values enables to enhance the balancing environment of the blockchain network by reducing the load of disk resources that is poor compared to relatively abundant network resources.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic diagram of a blockchain network which may implement a blockchain transaction processing method according to an exemplary embodiment of the present disclosure;

FIG. 2 is a schematic block diagram of a blockchain transaction processing apparatus that may operate as a full node providing another node with a state value for processing a blockchain transaction in the blockchain network of FIG. 1;

FIG. 3 is a schematic block diagram of a blockchain transaction processing apparatus that may operate as a full node receiving the state value for processing the blockchain transaction from another node in the blockchain network of FIG. 1;

FIG. 4 is a schematic block diagram of a blockchain transaction processing apparatus that may operate as a full node sharing the state value for processing the blockchain transaction from another node in the blockchain network of FIG. 1;

FIG. 5 illustrates an exemplary format of a state snapshot that may be adopted by full nodes sharing state values for blockchain transaction processing in the blockchain network of FIG. 11

FIG. 6 illustrates an alternative example of the state snapshot format of FIG. 5;

FIG. 7 illustrates another alternative example of the state snapshot format of FIG. 5;

FIG. 8 is a schematic block diagram of a blockchain node that receives the state value for processing the blockchain transaction from another node in the blockchain network of FIG. 1;

FIG. 9 is a block diagram illustrating a physical configuration of a blockchain node of the blockchain network shown in FIG. 1;

FIG. 10 is a flowchart for explaining a blockchain transaction processing method according to another exemplary embodiment of the present disclosure;

FIG. 11 is a flowchart for explaining a blockchain transaction processing method according to another exemplary embodiment of the present disclosure;

FIG. 12 is a flowchart for explaining a state value fetch procedure that may be additionally included in the blockchain transaction processing method of FIG. 11; and

FIG. 13 is a flowchart for explaining a state value removal procedure that may be additionally included in the blockchain transaction processing method of FIG. 11.

The drawings described herein are for illustration purposes only and are not intended to limit the scope of the present disclosure in any way.

### DETAILED DESCRIPTION

For a clearer understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

In the description of exemplary embodiments of the present disclosure, “at least one of A and B” may mean “at least one of A or B” or “at least one of combinations of one or more of A and B”. In addition, in the description of exemplary embodiments of the present disclosure, “one or more of A and B” may mean “one or more of A or B” or “one or more of combinations of one or more of A and B”.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings. In order to facilitate general understanding in describing the present disclosure, the same components in the drawings are denoted with the same reference signs, and repeated description thereof will be omitted.

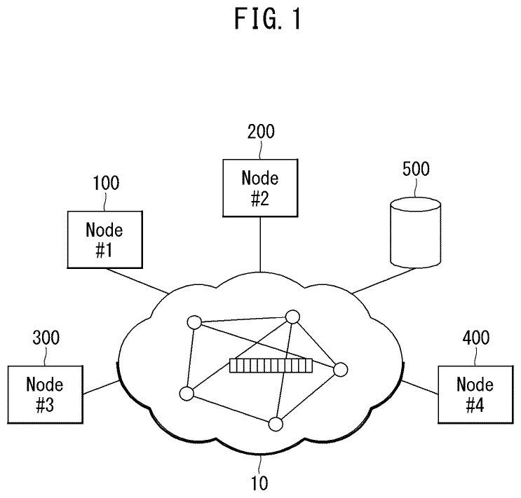

FIG. 1 is a schematic diagram of a blockchain network which may implement a blockchain transaction processing method according to an exemplary embodiment of the present disclosure.

Referring to FIG. 1, a first node 100, a second node 200, a third node 300, a fourth node 400, and a local disk 500 are communicatively connected to each other through a blockchain network 10, and each of the nodes 100-500 may operate as a blockchain node. In a broad sense, the blockchain network 10 may include the first node 100, the second node 200, the third node 300, the fourth node 400, and the local disk 500.

Here, it may be assumed that the first node 100 is a first full node, the second node 200 is a second full node, the third node 300 is a third full node, the fourth node 400 is a light node, and the local disk 500 is an authenticated data storage.

It may be assumed that the first full node is a node reading a state value directly from the local disk for the execution of the transaction of a certain block and providing a state value required for the execution of the transaction of the block to at least one other full node. The second full node may be a blockchain node receiving the state value required for the execution of the transaction of the block from another full node such as the first full node through the network. The third full node may be a blockchain node having a configuration or function of the second full node together with the configuration or function of the first full node.

According to the present embodiment, the first node 100 may be configured to read the state value from the local disk 500 to process the blockchain transaction of a new block, generate a state snapshot including the state value read from the local disk 500, and then share a generated state snapshot with the second node 200 and/or the third node 300.

The second node 200 may be configured to, when receiving the new block, receive the state value required to execute the blockchain transaction of the new block from the first node 100 and execute the transaction based on the received state value.

According to the configuration described, at least one full node including the second node 200 and/or the third node 300 may execute the transaction of the block, when receiving the new block, by using the state value received from the first node 100 instead of reading the necessary state value from the local disk, so that the disk load of the local disk may be reduced significantly and meaningfully due to the configuration.

Of course, some of the full nodes in the blockchain network may receive a new block and sequentially executes the transactions included in the block. In such a case, the full node has to read all the related state information stored in the Merkle tree in order to execute the transactions.

Assuming that k transactions are included each block, state read requests of l times are required to execute each transaction, and a total of n states are stored in the Merkle tree, disk read operations of O(kl log n) times are required for the processing of the transactions associated with the block excluding the use of the caching for convenience.

That is, all of the full nodes connected to the blockchain network may have to receive the new block of the same content, and complete the processing of all the transactions prior to receiving the new block and store updated state information which is the same as those in the other full nodes in a database (DB) of the local disk. For example, when the full nodes A and B receive the new block, each of the full nodes A and B may access its own local disk storing the same state information to read the necessary state values from the local disk according to a transaction order which is the same for the nodes. Accordingly, when the number of the full nodes in the entire blockchain network is N, the total number of disk read operations in the entire network for one new block may be O(kl log n).

According to an exemplary embodiment, in order to solve the problem that the full nodes perform the operation of reading the local disk redundantly, which causes a large load on the local disk, some of the full nodes may receive the state value required for the execution of the transaction from another full node already having read the state value from the local disk through the network instead that each of the full nodes reads the state value from respective local disk. Such a configuration enables to significantly reduce the number of disk read operations in the local disk.

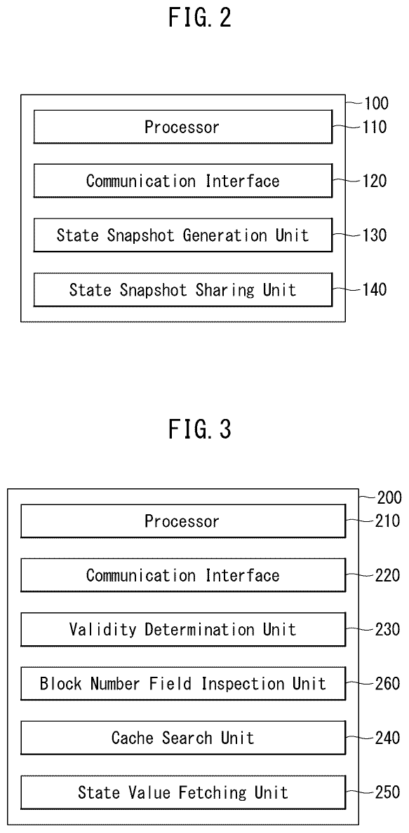

FIG. 2 is a schematic block diagram of a blockchain transaction processing apparatus that may operate as the full node providing another node with the state value for processing the blockchain transaction in the blockchain network of FIG. 1.

Referring to FIG. 2, the blockchain transaction processing apparatus 100 may include a processor 110, a communication interface 120, a state snapshot generation unit 130, and a state snapshot sharing unit 140, and may operate as the first full node.

The processor 110 may control the operation or function of the communication interface 120, the state snapshot generation unit 130, and the state snapshot sharing unit 140.

The communication interface 120 may be used to access the local disk and read a certain state value under the control of the processor 110.

The state snapshot generation unit 130 may generate a state snapshot in a predetermined format including the state value read from the local disk.

The state snapshot sharing unit 140 may share the state snapshot with other full nodes. The state value included in the shared state snapshot may be used by other full nodes to process the transactions of the new block without having to fetch the state value for the new block from their own local disks.

FIG. 3 is a schematic block diagram of the blockchain transaction processing apparatus that may operate as the full node receiving the state value for processing the blockchain transaction from another node in the blockchain network of FIG. 1.

Referring to FIG. 3, the blockchain transaction processing apparatus 200 may include a processor 210, a communication interface 220, a validity determination unit 230, a cache search unit 240, a state value fetching unit 250, and a block number field inspection unit 260, and may operate as the second full node.

The processor 120 may control the operation or function of the communication interface 220, the validity determination unit 230, the cache search unit 240, the state value fetching unit 250, and the block number field inspection unit 260.

The communication interface 220 may be used to access the local disk and read a certain state value under the control of the processor 210.

The communication interface 220 may receive the state snapshot broadcast by the first full node, or request the state value from the first full node and receive the state snapshot including the state value from the first full node under the control of the processor 210. The state snapshot received from the first full node may be stored in a state snapshot storage which may be a particular memory space of the second full node.

The validity determination unit 230 may validate the state value in the state snapshot received from the first full node. The validation may be performed using the Merkle proof.

When the new block is received and the transaction of the new block is to be executed, the cache search unit 240 may check or search whether the state value corresponding to the new block is stored in the cache of the second full node. The cache search unit 240 may request the state value from the cache and receive the state value in response from the cache.

When the state value of the new block is not stored in the cache, the state value fetching unit 250 may fetch the state value from the state snapshot storage by requesting the state value to the state snapshot storage and receiving the state value in response from the state snapshot storage.

The block number field check unit 260 may check the block number field of the state value stored in the cache or the state snapshot storage when the execution of the transaction for the block is completed. The state value may be discarded depending on a check result.

The validity determination unit 230, the cache search unit 240, the state value fetching unit 250, and the block number field check unit 260 may be implemented in the form of a single module such as a transaction executor.

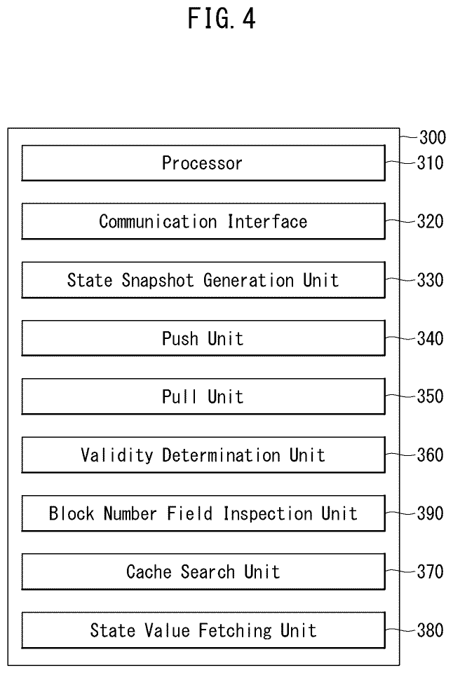

FIG. 4 is a schematic block diagram of the blockchain transaction processing apparatus that may operate as the full node sharing the state value for processing the blockchain transaction from another node in the blockchain network of FIG. 1.

Referring to FIG. 4, the blockchain transaction processing apparatus 300 may include a processor 310, a communication interface 320, a state snapshot generation unit 330, a push unit 340, a pull unit 350, a validity determination unit 360, a cache search unit 370, a state value fetching unit 380, and a block number field inspection unit 390, and may operate as the third full node having the configuration or function of the first full node as well as the second full node.

The processor 120 may control the operation or function of the communication interface 320, the state snapshot generation unit 330, the push unit 340, the pull unit 350, the validity determination unit 360, the cache search unit 370, the state value fetching unit 380, and the block number field inspection unit 390.

The configuration or function of the communication interface 320, the state snapshot generation unit 330, the push unit 340, the pull unit 350, the validity determination unit 360, the cache search unit 370, the state value fetching unit 380, and the block number field inspection unit 390 are substantially the same as the configuration or function of the corresponding component in the first full node illustrated in FIG. 2 or the component in the second full node illustrated in FIG. 3, and thus detailed description of the components is omitted for simplicity.

The push unit 340 and the pull unit 350 may be a specific implementation forms of the state snapshot sharing unit 140. The push unit 340 may refer to a functional unit or component that broadcasts the state snapshot to provide the state snapshot to at least some peer nodes in the blockchain network. The pull unit 350 may refer to a functional unit or component that provides the state snapshot to another full node in response to a request for the state value from the other full node.

According to the present embodiment, the third full node may operate as the first full node or the second full node whenever a new block is generated in the blockchain network.

Meanwhile, the structure of the third full node described above may be applied to any of the full nodes in the blockchain network. In such a case, the function of all the full nodes in the blockchain network may be set in advance such that at least one full node operates as the first full node and the remaining full nodes operate as the second full nodes. Alternatively, the function of all the full nodes may be set during a handshake process between the full nodes such that each full node may operate as the first full node or the second full node according to a preset setting or rule designated in advance between the full nodes.

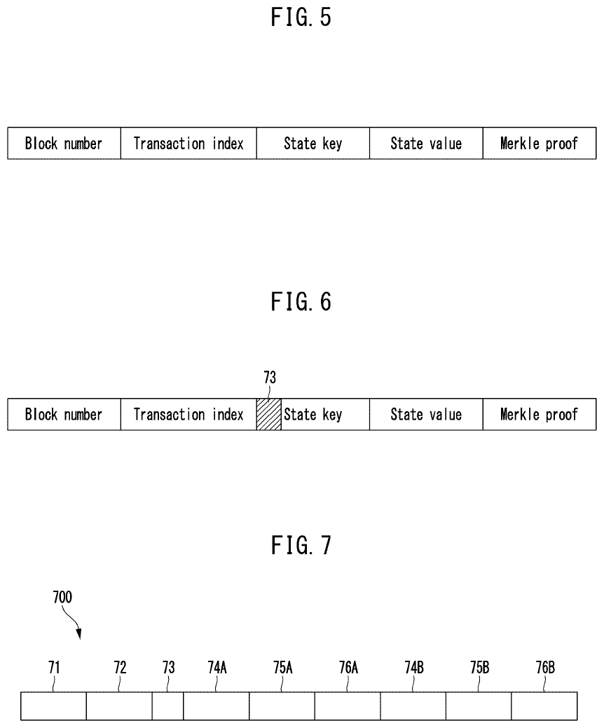

FIG. 5 illustrates an exemplary format of the state snapshot that may be adopted by the full nodes sharing the state values for blockchain transaction processing in the blockchain network of FIG. 1. FIG. 6 illustrates an alternative example of the state snapshot format of FIG. 5. FIG. 7 illustrates another alternative example of the state snapshot format of FIG. 5.

Referring to FIG. 5, the state snapshot format may include fields for a block number, a transaction index, a state key, the state value, and the Merkle proof.

To be more specific, it is to be noted that the state value of the blockchain is updated in units of the transaction during the process of executing a transaction. Thus, in order for the state value of a node A to be utilized in a node B, the state value should be accompanied with a time by which the state value is valid. For example, in case that a balance of a certain account address is read and shared, the balance value must indicate an effective time of the value, i.e. that it is a value at a time after executing which transaction of which block on the blockchain. Such a condition is not limited to the account balance but may be applicable equally to all the other blockchain states. In addition, when the node A transmits the state value to the node B, the Merkle proof may be required to validate the state value since there is no trust relationship between the blockchain nodes.

Accordingly, the state snapshot format of the present embodiment may include the block number field, the transaction index field, the state key field, the state value field, and the Merkle proof field as payloads. The Merkle proof is a set of values of all node on a path from a root node of a Merkle tree to a certain leaf state.

The state key and the state value may correspond to the account address and balance mentioned above. If there exists a plurality of states to be transmitted for the same block number and transaction index, the number of the states may be indicated in number of states field 73 preceding the state key field, the state value field, and the Merkle proof field as shown in FIG. 6.

For example, when the number of state values is 2, the payload of the state snapshot 700 may have a format in which the state value number field 73 is disposed after the block number field 71 and the transaction index field 72 and followed by the first state key field 74A, the first state value field 75A, and the first Merkle proof field 76B for a first state value, and the second state key field 74B, the second state value field 75B, and the second Merkle proof field 76B for a second state value as shown in FIG. 7.

The state snapshot having the payload format described above may be generated in the first full node and broadcast to at least one second full node. In such a process, the first full node and the second full node may determine to perform the sharing of the state snapshots in an initial peer connection handshake process. In particular, the full nodes may choose one of two schemes for transmitting the state snapshots, a push type scheme and a pull type scheme, during the handshake process.

In case that the push type scheme is chosen, the first full node may immediately transfer the state snapshot to the corresponding peer nodes, i.e., at least one second full node, as soon as the state snapshot is generated. In case that the pull type scheme is chosen, the first full node may transfer the state snapshot including the corresponding information, i.e., the corresponding state value, to the second full node in response to a request message for the state value from the corresponding peer node, i.e., the second full node.

Meanwhile, when the full node A executes the transaction included in the block, the full node A may create the state snapshot of the state values read from the local disk to execute the transaction. Such state values are information that the full node B needs to read from the local disk to execute the corresponding transaction. Therefore, when the full node B receives the state snapshot from the full node A, the transaction index and the block number in the state snapshot may point to the index of the transaction of which execution was completed at the time the state value was read from the local disk and the block number including the transaction. As a result, the full node B may execute the transaction of the block using the state value contained in the state snapshot.

The information required to create the state snapshot may be obtained during the transaction execution process without any additional burden, and thus the overhead for the state snapshot creation process may is low.

Meanwhile, when the full node B receives the state snapshot, the full node B may determine the validity of the state snapshot based on a current transaction executing state in full node B. If the block number and the transaction index of the state snapshot is earlier than the transaction currently being executed by the full node B, the state snapshot may be determined to be unnecessary information and may be ignored or discarded without being stored.

On the other hand, if the state snapshot received by the full node B is earlier than the transaction currently being executed, the full node B may store the state snapshot in its memory space. The memory space may be referred to as state snapshot storage. After the full node B completes the execution of the transaction of each block, the full node B may check the block number field of the state snapshot storage and remove the state snapshot from the memory if the state snapshot is determined to have been created earlier than the state value processed by the full node B itself.

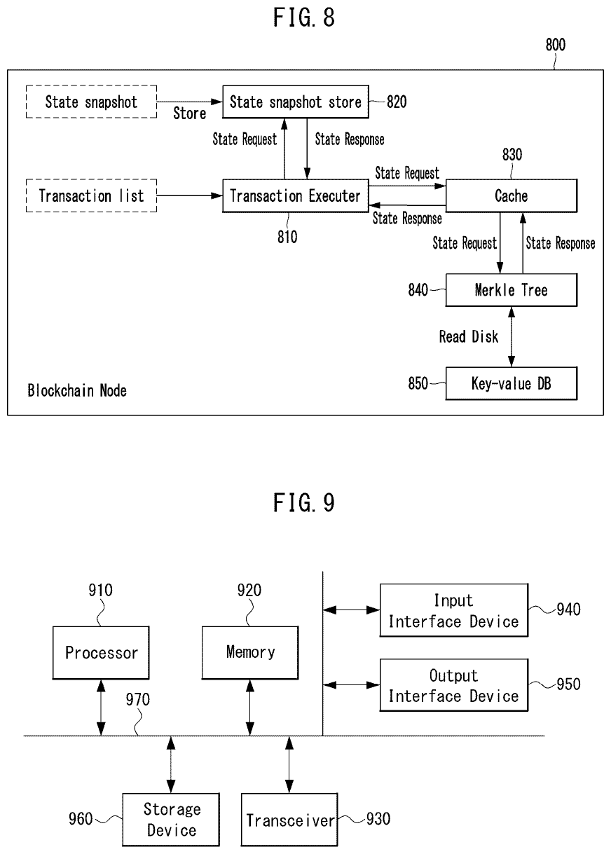

FIG. 8 is a schematic block diagram of a blockchain node that receives the state value for processing the blockchain transaction from another node in the blockchain network of FIG. 1.

Referring to FIG. 8, the blockchain node 800 may include a transaction executor 810, a state snapshot storage 820, a cache 830, a Merkle tree 840, and a Key-value database 850, and may operate as the second full node.

The blockchain node 800 may receive a state snapshot from the first full node and store it in the state snapshot storage 820. The transaction executor 810 may request the state value required to execute the transaction of the new block from the cache 830 based on a transaction list for the new block. The state value request may be simply referred to as a state request.

The cache 830 may request the state value from the Merkle tree 840 in response to a state value request from the transaction executor 810. The Merkle tree 840 may search for a corresponding key-value in the key-value DB 850 equipped in the memory or disk of the blockchain node 800. The cache 830 can receive a state value response from the Merkle tree 840.

If it is determined, based on the state value response from the Merkle tree 840, that there is no state value for executing the transaction of the new block, the cache 830 may transmit a state value response including an indication of an absence of the state value to the transaction executor 810.

In the above-described case, the transaction executor 810 may request the state value from the state snapshot storage 820 through a state value fetching unit (not shown). The state value fetching unit may fetch the state snapshot stored in the state snapshot storage 820 and acquire the state value from the state snapshot to provide to the transaction executor 810 through a state value response.

Then, the transaction executor 810 may execute a corresponding transaction using the state value received from the state snapshot storage 820.

According to the configuration described above, the blockchain node which is the second full node may process the transaction of the block using the state value in the state snapshot received from the first full node instead of reading the state value from the local disk in the blockchain node itself.

According to the configuration described above, the blockchain node 800 may operate as the second full node which receives the state snapshot including the necessary state value from the first full node and processes the transaction of the block using the state value acquired from the state snapshot received from the first full node.

For example, the blockchain node 800 may be in a state of having completed the execution of the transaction included in an i-th block and having stored a final state value in the local DB of the local disk, where i is an arbitrary any natural number. Then, the blockchain node 800 may receive an (i+1)-th block to prepare for the transaction execution, and may receive the state snapshot in which the block number is set to i+1. In this case, the blockchain node 800 may intentionally wait for the state snapshot of which the block number is set to (i+1) before starting executing the transaction of the (i+1)-th block in order to reduce the number of disk read operations. In addition, if a state value required for the sequential execution of the transaction of the (i+1)-th block does not exist in the cache 830, the blockchain node 800 may fetch the state value from the state snapshot storage 820 instead of requesting from the local disk. According to the present embodiment, the blockchain node 800 enables to reduce the number of the state value requests to the local disk and significantly reduce the number of local disk read operations by using the state snapshot storage.

FIG. 9 is a block diagram illustrating a physical configuration of the blockchain node of the blockchain network shown in FIG. 1.

Referring to FIG. 9, a blockchain transaction processing apparatus (hereinafter, referred to as a ‘computing device’) 900 may include at least one processor 910, a memory 920, and a transceiver 930 that may be connected to a network and perform communications with another device. In addition, the computing device 900 may further include an input interface device 940, an output interface device 950, and a storage device 960. The components in the computing device 900 may be connected to each other by a bus 970.

However, each component in the computing device 900 may be connected through an individual interface or an individual bus disposed to be connected to the processor 910, rather than the common bus 970. For example, the processor 910 may be connected to at least one of the memory 920, the transceiver 930, the input interface device 940, the output interface device 950, and the storage device 960 through a dedicated interface.

The processor 910 may execute program instructions stored in at least one of the memory 920 and the storage device 960. The processor 910 may include a central processing unit (CPU) or a general-purpose processing unit (GPU) or may be implemented by another kind of dedicated processor suitable for performing the method of the present disclosure. Each of the memory 920 and the storage device 960 may be comprised of at least one of a volatile storage medium and a non-volatile storage medium. For example, the memory 920 may be comprised of at least one of a read only memory (ROM) and a random access memory (RAM).

The program instructions may include at least one instruction suitable for implementing a blockchain transaction processing method. The at least one instruction may cause the processor to: receive a new block, access the local disk, read a required state value from the local disk, create a state snapshot including the state value, share the state snapshot with another full node (i.e., a second full node), receive the state value required to execute the transaction of the new block from another full node (i.e., a first full node), verify the validity of the received state value, store the state value in a particular memory space of a memory or storage, ignore or discard the state value, determine whether the state value exists in a cache, fetch the state value from the memory space, check a block number field of the state value stored in the memory space, and remove the state value obtained from the state snapshot if a result of the checking the block number field shows that the state value obtained from the state snapshot has been created earlier than the state value processed by the node itself,

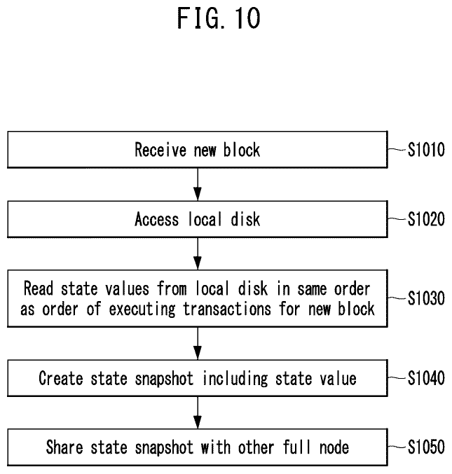

FIG. 10 is a flowchart for explaining a blockchain transaction processing method according to another exemplary embodiment of the present disclosure.

Referring to FIG. 10, a blockchain transaction processing apparatus, which is a first full node capable of providing the state value for the blockchain transaction processing to another full node in the blockchain network, may receive a new block through the blockchain network (S1010). The new block received by the first full node may have been generated by a block generator node having sequentially executed transactions stored in a local mempool and updated a relevant state, and includes, in its block header, a newly calculated state root which is a hash value for the entire states.

Subsequently, the first full node may access the local disk to process the transactions of the new block (S1020). The transaction processing may include the execution of the transactions and the update of the states. The local disk may be an authenticated data storage in the blockchain network. Such a data storage may be equipped with a database (DB) system and may allow the blockchain node to access the state values stored in the database of the DB system.

Next, the first full node may read the necessary state values from the local disk in the same order as the order of executing the transactions for the new block (S1030). Using these state values, the first full node may execute the transactions contained in the block sequentially in the order of executing the transactions, update the state stored in the node itself, and verify an update result by calculating the state root and comparing with the value in the block header.

Then, the first full node may create the state snapshot including the validated state value (S1040). The state snapshot, which is newly defined in the present disclosure, may be used for the full nodes in a blockchain network to share the transaction state values with other nodes. The format of the state snapshot may have any of the formats shown in FIGS. 5-7.

Next, the first full node may share the generated state snapshot with at least one other full node in the blockchain network. The at least one other full node may be designated to be at least one second full node. The sharing of the state snapshot may be accomplished by the push type scheme in which the at least one second full node receives a signal or message including the state snapshot from the first full node, or the pull type scheme in which the at least one second full node requests and receives the state snapshot from the first full node according to the preset setting or rule specified during the handshake with the first full node.

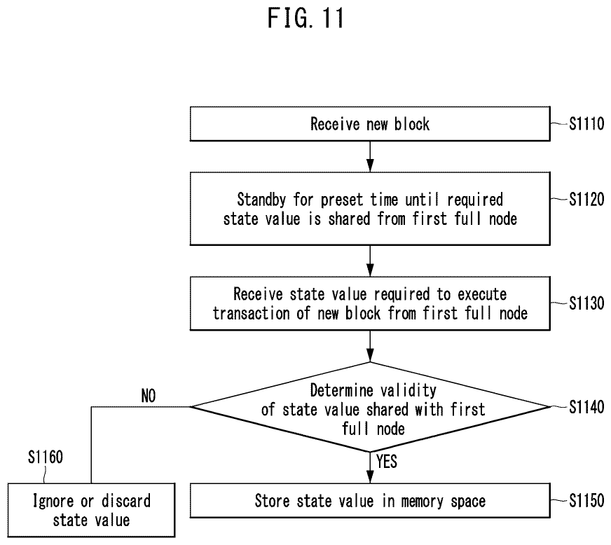

FIG. 11 is a flowchart for explaining a blockchain transaction processing method according to another exemplary embodiment of the present disclosure.

Referring to FIG. 11, a blockchain transaction processing apparatus, which is a second full node capable of receiving the state value for the blockchain transaction processing from another full node in the blockchain network, may receive a new block through the blockchain network (S1110). Typically, the full node has to maintain the entire state information of the blockchain in the local storage which is an authenticated data storage of the node. When a light node that does not have at least some of blockchain ledger information requests a state value, the full node may verify an integrity of a received state value using a proof.

Subsequently, the second full node may receive the state value required to execute the transaction of the new block from the first full node (S1130). At this time, the second full node can directly access the local disk to read the required state value, but may stand by for a preset time until the required state value is shared from the first full node in order to reduce the load on the local disk (S1120). During the standby time, the second full node may receive the state value broadcast from the first full node in the push type scheme, or request and receive the required state value from the first full node in the pull type scheme.

Next, the second full node may determine the validity of the state value shared from the first full node (S1140). In the blockchain network, since the state value is updated in units of the transaction during the process of executing the transaction, the state value should be accompanied with the time by which the state value is valid in order for the state value of a certain blockchain node to be utilized in another blockchain node. For example, in case that the second full node reads the balance of a certain account address, the state value of the read balance must indicate or have information about an effective time of the value, i.e. that it is a value after executing which transaction of which block on the blockchain. In particular, since there is no separate process for verifying the trust between the blockchain nodes, a Merkle proof may be required to validate that the state value when the first node provides the state value to the second node. The Merkle proof is a set of values of all nodes on a path from the root node of the Merkle tree to a certain leaf state, and is used when a light node requests and validates information from a full node in the blockchain network. In this way, the second full node may validate the state value received from the first full node using the proof such as the Merkle proof.

When the state value shared from the first full node is valid (i.e. it is determined to be ‘YES’ in the operation S1140), the second full node may store the state value in the memory space (S1150). As a result, the state value may be transferred from the first full node to the second full node in a state of being included in the state snapshot according to the present disclosure. The memory space of the second full node storing the state snapshot may be referred to as the state snapshot storage as mentioned above.

Meanwhile, when the state value shared from the first full node is not valid (i.e. it is determined to be ‘NO’ in the operation S1140), the second full node may ignore or discard the state value (S1160).

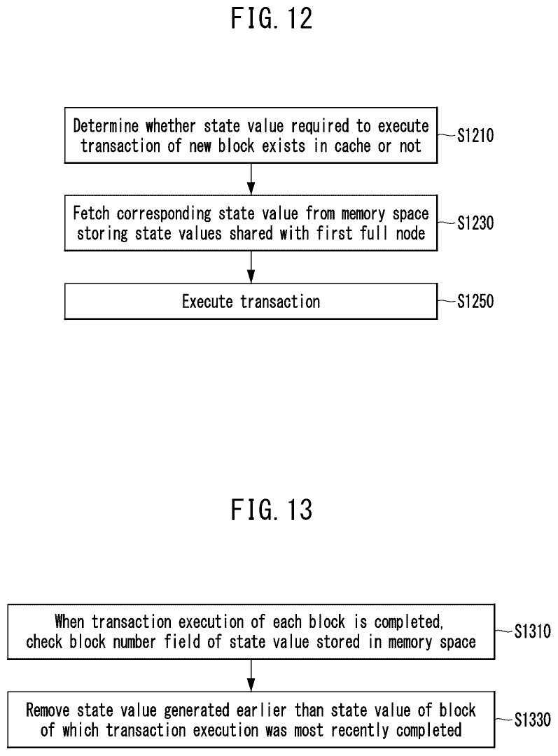

FIG. 12 is a flowchart for explaining a state value fetch procedure that may be additionally included in the blockchain transaction processing method of FIG. 11.

Referring to FIG. 12, after receiving the new block, or after receiving the new block, receiving the state snapshot, validating the state value, and storing a validated state value in the state snapshot storage, the second full node may check or determine whether the state value required for executing the transaction of the new block exists in the cache or not (S1210). During this stage, the transaction executor of the second full node may request the state value from the cache and receive the state value response from the cache.

When the required state value does not exist in the cache, the second full node may fetch the state value from the state snapshot storage by requesting the state value from the memory space of the state snapshot storage that stores the state values shared with the first full node (S1230). In response to the state value request of the transaction executor, the state snapshot storage may extract the state value from the memory space and provide the state value response to the transaction executor.

According to the procedure described above, the transaction executor of the second full node may store the state snapshot received from the first full node into the state snapshot storage and execute the transaction based on the stored state snapshot (S1250).

FIG. 13 is a flowchart for explaining a state value removal procedure that may be additionally included in the blockchain transaction processing method of FIG. 11.

Referring to FIG. 13, when the execution of the transaction of a block is completed, the second full node may check the block number field for the state value of the corresponding block stored in a particular memory space of the state snapshot storage (S1310). The block number field may be one of the fields included in the state snapshot in which the state value is stored.

Then, the second full node may remove the state value generated earlier than the state value of the block of which transaction execution was most recently completed (S1330).

According to the state value removal procedure described above, the second full node may efficiently use its memory space.

As a result, an exemplary embodiment of the present disclosure enables to reduce the burden of reading the local disk required for the execution of the transaction, thereby shorten the execution time required for the transaction and increase the lifespan of the local disk while allowing to maintain a node system and a data storage structure of the existing blockchain and thus.

In this way, by utilizing the present disclosure, the node system and data storage structure of the existing blockchain can be maintained, while reducing the reading burden of the local disk required for transaction execution, thereby shortening the transaction execution time and increasing the lifespan of the local disk.

The device and method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A blockchain transaction processing method performed by a first full node, comprising:
reading a state value required for processing a transaction of a new block from a local disk in a same order as an order of processing transactions of a plurality of new blocks;
creating a state snapshot including the state value; and
sharing the state snapshot with at least one second full node.

2. The blockchain transaction processing method of claim 1, wherein a format of the state snapshot comprises a block number field, a transaction index field, a state key field, a state value field, and a Merkle proof field.

3. The blockchain transaction processing method of claim 2, wherein the format of the state snapshot comprises a number of state values field.

4. The blockchain transaction processing method of claim 1, wherein sharing the state snapshot with at least one second full node comprises:
transferring the state snapshot by broadcast to peer nodes and transmitting the above state snapshot to peer nodes including at least one other full node of the blockchain network.

5. The blockchain transaction processing method of claim 4, wherein, in transferring the state snapshot, a scheme for the at least one second full node to receive the state snapshot is set in advance during a handshake between the first full node and the at least one second full node.

6. The blockchain transaction processing method of claim 4, wherein the scheme for the at least one second full node to receive the state snapshot includes a push type receiving scheme and a pull type receiving scheme,
wherein the push type receiving scheme comprises:
receiving, by the first full node, a sharing request for the state snapshot from the at least one second full node; and
transmitting the state snapshot to the at least one second full node.

7. The blockchain transaction processing method of claim 1, further comprising:
receiving another state snapshot including another state value for another new block from a full node belonging to the at least one second full node.

8. A blockchain transaction processing method performed by a second full node, comprising:
receiving a new block; and
receiving a state snapshot including a state value required to process a transaction of a new block from a first full node to share the state snapshot with the first full node.

9. The blockchain transaction processing method of claim 8, wherein a format of the state snapshot comprises a block number field, a transaction index field, a state key field, a state value field, and a Merkle proof field.

10. The blockchain transaction processing method of claim 8, further comprising:
determining a validity of the state value based on a block number and a transaction index included in the state snapshot.

11. The blockchain transaction processing method of claim 10, further comprising:
when the state value is valid, storing the state value in a memory storage; and
when the state value is not valid, ignoring or discarding the state value.

12. The blockchain transaction processing method of claim 11, further comprising:
when there exist a plurality of new blocks, checking the block number field for the state value stored in a particular memory space whenever an execution of the transaction is completed; and
removing the state value generated earlier than a state value of a block of which transaction execution was most recently completed.

13. The blockchain transaction processing method of claim 8, wherein receiving the state snapshot is performed according to a receiving scheme set in advance during a handshake with the first full node.

14. The blockchain transaction processing method of claim 13, wherein the receiving scheme includes a push type receiving scheme and a pull type receiving scheme,
wherein receiving the state snapshot according to the push type receiving scheme comprises:
transmitting a request message to the first full node to request the state value; and
receiving the state snapshot comprising the state value.

15. The blockchain transaction processing method of claim 8, further comprising:
standing by for a preset time until receiving the state value required to process the transaction of the new block from the first full node.

16. The blockchain transaction processing method of claim 8, further comprising:
determining whether the state value required to process the transaction of the new block exists in a cache; and
if the state value required to process the transaction of the new block does not exist in the cache, fetching the state value from a memory space storing the state value shared with the first full node to process the transaction.

17. A blockchain transaction processing apparatus controlling and operating a blockchain node implemented based on a desktop computer or a mobile terminal participating in a blockchain network, comprising:
a processor configured to receive at least one instruction from a memory and execute the at least one instruction,
wherein the processor is caused by the at least one instruction to:
access a local disk storing state information shared between full nodes;
read a state value required for processing a transaction of a new block from the local disk in a same order as an order of processing transactions of a plurality of new blocks;
create a state snapshot including the state value; and
share the state snapshot with other nodes including at least one second full node.

18. The blockchain transaction processing apparatus of claim 17, wherein a format of the state snapshot comprises a block number field, a transaction index field, a state key field, a state value field, and a Merkle proof field.

19. The blockchain transaction processing apparatus of claim 18, wherein the at least one instruction causing the processor to share the state snapshot with other nodes is configured to cause the processor to:
transfer the state snapshot by broadcast to nodes including the at least one second full node of the blockchain network,
wherein a receiving scheme of the nodes is set in advance during a handshake with the first full node providing the state snapshot.

20. The blockchain transaction processing apparatus of claim 17, wherein the other nodes include at least one of a desktop wallet, a mobile wallet, a hardware wallet, and a web wallet.
